(19) United States
(12) Patent Application Publication
(10) Pub. No.: US 2012/0222339 A1
(43) Pub. Date: Sep. 6, 2012

(54) Collaborative advertising method and vessel for regional businesses

(76) Inventor: Steven J. Dubinski, Bloomington, IL (US)

(21) Appl. No.: 12/932,679

(22) Filed: Mar. 3, 2011

(51) Int. Cl. G09F 3/00

(52) U.S. Cl. 40/324

(57) ABSTRACT

A collaborative advertising method and vessel enables regionally located businesses to simultaneously advertise to beverage consumers. The method comprises the steps of selecting and/or identifying a target advertising region selecting group of businesses from within the target advertising region. The businesses each contribute business-identifying and/or advertising media for display upon an advertising vessel, preferably in the form of a drinking vessel. The business-identifying information or select provider identifiers of beverage provider businesses are each featured on the vessel and advertisements flank the featured business identifier. The vessels are distributed to the beverage providers with primarily displayed select provider identifiers and secondarily displayed select advertisements. The vessels are served to customers at beverage provider establishments thereby exposing the customers to the primarily displayed select provider identifiers and secondarily displayed select advertisements.

### BACKGROUND OF THE INVENTION

1. Field of the Invention

The present invention generally relates to an advertising method for regionally located businesses. More particularly, the present invention relates to a collaborative advertising method whereby regionally located businesses simultaneously exhibit advertisements to would-be customers while featuring a beverage provider identifier upon a drinking vessel.

2. Brief Description of The Prior Art

The field and/or art of advertising and the like is/are well-developed. Glassware based advertising and collaborative advertising represent smaller sections of advertising methodology within the larger field of advertising. Some of the more pertinent prior art relating to glassware based advertising and/or collaborative type advertising is briefly described hereinafter. Most of the art related to glassware based advertising focuses on the structural characteristics of the advertising vehicle or medium.

U.S. Pat. No. 3,413,743 ('743 patent), which issued to Goodhue, for example, discloses a Low Profile Embossed-Debossed Printing on a Closure. The '743 Patent describes a closure having low profile printing formed by embossing the letters and debossing the area surrounding the letters. The letters forming the printing on the closure are embossed or raised only a slight distance above the plane of the background. To give the letters the appearance of a greater height a debossing channel is placed around the periphery of the letters. The letters now give an appearance of having a substantial height whereas the letters are only raised a slight distance above the plane of the background.

U.S. Pat. No. 3,874,977 ('977 patent), which issued to Pyles, discloses Decorative Glassware. The '977 patent describes a decorated article of glassware and the like and a method of making the same in which a glass object having a cylindrical sidewall is provided with a pair of separate and distinct designs separated by a neutral background and an opening through both designs and background forming an integral part of the outermost design through which a viewer may see the innermost design through the glass sidewall.

U.S. Pat. No. 4,290,533 ('533 patent), which issued to Rupp et al. discloses a Ceramic Decorated Glassware. The '533 patent describes halftone printing of a plurality of different colors to produce a composite graphic display on the surface of the glass. Precise alignment is utilized in order to register the halftone printing screens for each color that is deposited on the glass surface. The opaque enamels employed in the decorative process are carefully balanced with respect to each other to obtain the desired color hues. The deposition angles for the alignment of the halftone dots are controlled to minimize the undesirable moire effect.

U.S. Pat. No. 4,883,187 ('198 patent), which issued to Knitzer, discloses a Soft Drink Advertising Device. The '198 patent describes an advertising device, comprising a sidewall defining an internal volume for containing a liquid and having an upper open portion and a bottom portion is disclosed. A bottom member closes the said bottom portion. The upper portion of the sidewall extends inward in the region of the upper portion which is uppermost on the tubular sidewall. A bead extends along the outside parameter of the said radially inwardly extending portion of the tubular sidewall.

A cap has a tubular sidewall whose cross-sectional shape substantially coincides with the cross-sectional shape of that portion of the tubular sidewall between the upper portion of the tubular sidewall and the lower portion of the sidewall. A top member is secured along the inside of the cap sidewall, the top closing said cap. The inside of the cap sidewall is configured to grip the head to securely close the upper portion with the cap top. The inside of the cap bottom, has ridges or protrusions, to hold the glass steady when the cap is being used as a coaster.

U.S. Pat. No. 5,333,909 ('909 patent), which issued to Hedge, Jr. discloses Promotional Advertising Brochure including Reusable Envelope Device. The '909 patent describes a combined advertising brochure and separable reusable envelope device formed from a rectangular sheet being portioned and folded through the application of grouped parallel scorelines and/or perforation lines. Additional format ad space is provided amidst given vertex fold points through the mounting of preassembled leaflet configurations, either of which are attached to the brochure via a release adhesive.

The further formation of a separable reusable envelope, and accompanying ad contents, becomes incorporated on at least one end of the brochure embodiment. Furthermore, the free standing aftermarket envelope portion becomes closed through the engagement of the tuck-in tongue enablements. Likewise, the aftermarket envelope is enhanced with a categorical title strip located about the exposed inside back panel of the envelope. Moreover, the aftermarket envelope portionment is further enhanced via the (landscape) pictorial ad field which spans the aftermarket envelope's front side.

U.S. Pat. No. 7,650,431 ('431 patent), which issued to Wang et al., discloses a method for Serving Locally Relevant Advertisements. The '431 patent describes a method and system for providing location-based advertisements to requesting devices. An advertisement system aggregates advertisements by collecting advertisements from multiple advertisement sources, extracting data from the collected advertisements, and storing the extracted data in a common format.

After aggregating the advertisements, the advertisement system transforms each advertisement into multiple advertisement formats that are specific to protocols supported by the various device types. When the advertisement system receives queries for advertisements, it identifies matching advertisements and ranks them based on a location. The advertisement system then selects an advertisement format that is appropriate for the requesting device.

United States Patent Application No. 2006/0124561 which was authored by Bhavnani, describes a beverage container having at least two curved sides which meet at rounded lengthwise edges, having improved pouring and liquid flow characteristics, which may be used with a sealed lid and is capable of being tightly nested with other like shaped containers. The container also presents increased and improved outer surface areas, which more readily facilitate commercial or advertising graphic imprinting. The container comprises an inner and outer shell with the outer shell and may further include a snug fitting lid to facilitate the use of the container for travel.

United States Patent Application No. 2007/0131700 which was authored by Honkawa et al., describes certain methods and systems for a reusable container for the point-of-sale display and advertisement of beverages. The container generally comprises an open end, a drinker-friendly lip disposed around the open end, and a lid adapted to fit substantially around the lip to prevent the beverage from leaking out of the container. Graphics may be printed on the container comprising a company logo or an advertisement for the beverage. Instructions may also be provided that the container is reusable as a drinking glass at home.

United States Patent Application No. 2010/0193388 which was authored by Wright, describes a beverage status indicator device includes a beverage attachment temporarily positioning the device to a beverage container, a status display displaying a current status of the beverage, and, optionally, an advertisement area displaying an advertisement.

From a consideration of the foregoing, it will be noted that the prior art appears to be silent on a collaborative advertising method whereby regionally located businesses may cooperably submit advertisements and/or business-identifying information for placement upon individual drinking vessels that feature or highlight a beverage provider's house logo or similar other identifier while flanking the featured house identifier with a series of particularly arranged non-competitive advertisements. Accordingly, the prior art perceives a need for a collaborative advertising method for enabling regionally located businesses to simultaneously advertise to beverage consumers who are typically and reliably recognized as a captive audience. Which method is described and/or summarized in more detail hereinafter.

### SUMMARY OF THE INVENTION

To achieve these and other readily apparent objectives, the present specifications describe and/or set forth certain collaborative advertising methodologies for enabling regionally located advertisers/businesses to simultaneously and directly advertise to beverage consumers at regionally located beverage provider establishments. It is contemplated that the collaborative advertising or business method may be said to comprise a series of steps which steps are tied to an individual drinking vessel outfitted or provided with a series of advertisements adjacent to, or in support of, a featured beverage provider identifier, trademark, or logo.

Initially, a target geographic location is selected. Given the selection of a target geographical location, the same may be divided into a series of target advertising regions. Particular target advertising regions from within the selected geographic location may be identified and solicited with proposals for the cooperably engaging in or taking part in the described advertising scheme. Within a given target advertising region are potential beverage providers and potential collaborative advertisers.

The beverage providing businesses necessarily require glassware or other drinking vessels in which to serve beverages to customers who patron their establishments. These beverage providers typically have their own beverage provider identifier, trademark, or logo, which provider identifier may be featured upon the glassware free of charge, the same being possible by the advertising revenue generated from a series of advertisements aligned aside or flanking the featured provider identifier circumferentially spaced from the provider identifier.

The advertising method according to the present invention thus essentially attempts to highlight or feature the beverage provider identifier for any given beverage provider establishment while simultaneously exhibiting advertisements in support of the establishment identifier. The beverage provider identifier is featured or highlighted by prominently displaying the identifier upon pint glasses or similar other drinking vessels and flanking the identifier with grouped advertisements circumferentially spaced around the transverse perimeter of the glass or drinking vessels in secondary positions relative to the prominent position of the provider identifier.

The beverage provider identifier occupies a first or primary circular arc length section of a drinking vessel, and the advertisements are preferably and randomly grouped into flanking columns and marked upon second and third (or secondary) circular arc-length sections. The advertisers thus collaborate to provide advertisements which are aligned; set into columns; and positioned upon glassware or similar other drinking vessels 19 so as to flank the featured identifier. The columns comprise a number of select advertisements preferably divided lengthwise into a number of advertisement slots, each of which is paid for by a select advertiser.

It is contemplated that the advertisements may be randomly positioned within the columns and that the columns may be randomly positioned to either the left or the right or the prominently displayed provider identifier. In the preferred embodiment and method, it is contemplated that three advertisements may be randomly aligned into a first column and three advertisements may be randomly aligned into a second column.

In terms of marking the glassware or drinking vessels, it is contemplated that state of the art marking techniques may be used. However, it is further contemplated that the preferred marked drinking vessels comprise a solid backdrop color layer firstly layered upon the drinking vessel upon which a second layer of print material is positioned so as to provide duotone vessels so as to enhance the overall visual appeal of the drinking/advertising vessel. The beverage providers may thus select a color scheme according to their tastes or target consumer.

The foregoing color scheme examples are contemplated as examples of preferred types of color schemes. Other color schemes are also contemplated. Further, it is contemplated that the beverage provider may elect a single layer of colored material(s) or monochromic portrayal of the various advertisements and beverage provider identifiers directly upon the clear glass material of the drinking vessel either in negative or positive formats.

### BRIEF DESCRIPTION OF THE DRAWINGS

Other features of my invention will become more evident from a consideration of the following brief descriptions of patent drawings:

FIG. 1 is a first elevational view of a drinking vessel depicting a first beverage provider identifier marked and centered upon a first or primary circular arc length section of the drinking vessel.

FIG. 1(a) is a second elevational view of the drinking vessel otherwise shown in FIG. 1 rotated 120 degrees counter-clockwise around the vessel's axis to depict a first flanking advertisement column of a first marked batch, marked and centered upon a second or secondary circular arc length section of the drinking vessel.

FIG. 1(b) is a third elevational view of the drinking vessel otherwise shown in FIG. 1 rotated 120 degrees clockwise around the vessel's axis to depict a second flanking advertisement column of a first marked batch, marked and centered upon a third or secondary circular arc length section of the drinking vessel.

FIG. 1(c) is an enlarged fragmentary sectional view as sectioned from FIG. 1(a) depicting green text/imagery upon a yellow background color scheme.

FIG. 1(d) is an enlarged fragmentary sectional view as sectioned from FIG. 1 at “A-A” depicting a longitudinal section at the site of the vessel-marked, first beverage provider identifier, and showing from left to right, a base material layer, a first color layer, and a second color layer.

FIG. 1(e) is a first enlarged fragmentary sectional view as sectioned from FIG. 1 at “B-B” depicting a transverse section through the vessel-marked, first beverage provider identifier showing from the inner to outer layers: a base material layer, a first color layer, and a second color layer.

FIG. 1(f) is a second enlarged fragmentary sectional view as sectioned from FIG. 1 at “B-B” depicting a transverse section through the vessel-marked, first flanking advertisement column showing the inner to outer layers: a base material layer, a first color layer, and a second color layer.

FIG. 1(g) is a third enlarged fragmentary sectional view as sectioned from FIG. 1 at “B-B” depicting a transverse section through the vessel-marked, second flanking advertisement column showing the inner to outer layers: a base material layer, a first color layer, and a second color layer.

FIG. 2 is a first elevational view of a drinking vessel depicting the first beverage provider identifier of a second marked batch, marked and centered upon a first or primary circular arc length section of the drinking vessel.

FIG. 2(a) is second elevational view of the drinking vessel otherwise shown in FIG. 2 rotated 120 degrees counter-clockwise around the vessel's axis to depict a first flanking advertisement column of a second marked batch, marked and centered upon a second or secondary circular arc length section of the drinking vessel.

FIG. 2(b) is third elevational view of the drinking vessel otherwise shown in FIG. 2 rotated 120 degrees clockwise around the vessel's axis to depict a second flanking advertisement column of a second marked batch, marked and centered upon a third or secondary circular arc length section of the drinking vessel.

FIG. 2(c) is an enlarged fragmentary sectional view as sectioned from FIG. 2(a) depicting black text/imagery upon a white background color scheme.

FIG. 3 is a first elevational view of a drinking vessel depicting the first beverage provider identifier of a third marked batch, marked and centered upon a first or primary circular arc length section of the drinking vessel.

FIG. 3(a) is second elevational view of the drinking vessel otherwise shown in FIG. 3 rotated 120 degrees counter-clockwise around the vessel's axis to depict a first flanking advertisement column of a third marked batch, marked and centered upon a second or secondary circular arc length section of the drinking vessel.

FIG. 3(b) is third elevational view of the drinking vessel otherwise shown in FIG. 3 rotated 120 degrees clockwise around the vessel's axis to depict a second flanking advertisement column of a third marked batch, marked and centered upon a third or secondary circular arc length section of the drinking vessel.

FIG. 3(c) is an enlarged fragmentary sectional view as sectioned from FIG. 3(a) depicting green text/imagery upon a white background color scheme.

FIG. 4 is a first elevational view of a drinking vessel depicting a second beverage provider identifier marked and centered upon a first or primary circular arc length section of the drinking vessel.

FIG. 4(a) is a second elevational view of the drinking vessel otherwise shown in FIG. 4 rotated 120 degrees counter-clockwise around the vessel's axis to depict a first flanking advertisement column of a first marked batch, marked and centered upon a second or secondary circular arc length section of the drinking vessel.

FIG. 4(b) is a third elevational view of the drinking vessel otherwise shown in FIG. 4 rotated 120 degrees clockwise around the vessel's axis to depict a second flanking advertisement column of a first marked batch, marked and centered upon a third or secondary circular arc length section of the drinking vessel.

FIG. 4(c) is an enlarged fragmentary sectional view as sectioned from FIG. 4(a) depicting orange text/imagery upon a blue background color scheme.

FIG. 4(d) is an enlarged fragmentary sectional view as sectioned from FIG. 4 at “A-A” depicting a longitudinal section at the site of the vessel-marked, second beverage provider identifier, and showing from left to right, a base material layer, a first color layer, and a second color layer.

FIG. 4(e) is a first enlarged fragmentary sectional view as sectioned from FIG. 4 at “B-B” depicting a transverse section through the vessel-marked, second beverage provider identifier showing from the inner to outer layers: a base material layer, a first color layer, and a second color layer.

FIG. 4(f) is a second enlarged fragmentary sectional view as sectioned from FIG. 4 at “B-B” depicting a transverse section through the vessel-marked, first flanking advertisement column showing the inner to outer layers: a base material layer, a first color layer, and a second color layer.

FIG. 4(g) is a third enlarged fragmentary sectional view as sectioned from FIG. 4 at “B-B” depicting a transverse section through the vessel-marked, second flanking advertisement column showing the inner to outer layers: a base material layer, a first color layer, and a second color layer.

FIG. 5 is a cartoon type depiction of a select advertisement being randomly selected from a hat.

FIG. 6 is an advertisement column showing the randomly selected select advertisement from FIG. 5 being added to the bottommost position of a four-slot advertising column as positioned and centered upon a second or secondary circular arc length section of a phantom drinking vessel.

FIG. 7 is a diagrammatic type transverse sectional depiction showing a three-advertisement column arrangement circumferentially spaced adjacent a beverage provider identifier, the beverage provider identifier and three advertisement columns being centered on circular arc length sections of a phantom drinking vessel each subtended by 90 degrees.

FIG. 8 is a diagrammatic type transverse sectional depiction showing a four-advertisement column arrangement circumferentially spaced adjacent a beverage provider identifier, the beverage provider identifier and four advertisement columns being centered on circular arc length sections of a phantom drinking vessel each subtended by 72 degrees.

FIG. 9 is a diagrammatic type transverse sectional depiction showing a two-advertisement column arrangement circumferentially spaced adjacent a beverage provider identifier, the beverage provider identifier and two advertisement columns being centered on circular arc length sections each subtended by 120 degrees.

FIG. 9(a) is a first enlarged fragmentary sectional view as sectioned from FIG. 9 depicting a transverse section through the vessel-marked, beverage provider identifier showing from the inner to outer layers: a base material layer, a first color layer, and a second color layer.

FIG. 9(b) is a second enlarged fragmentary sectional view as sectioned from FIG. 9 depicting a transverse section through the vessel-marked, first flanking advertisement column showing the inner to outer layers: a base material layer, a first color layer, and a second color layer.

FIG. 9(c) is a third enlarged fragmentary sectional view as sectioned from FIG. 9 at depicting a transverse section through the vessel-marked, second flanking advertisement column showing the inner to outer layers: a base material layer, a first color layer, and a second color layer.

FIG. 10 is a generic, rectangular map of a target geographical location showing four target advertising regions divided into four quadrants of the rectangular map.

FIG. 11 is an enlarged view of the first quadrant of the rectangular map otherwise depicted in FIG. 10, which quadrant depicts (1) twenty circles as symbolic of beverage provider establishments, and (2) six triangles as symbolic of collaborative advertisers.

FIG. 12 is a flowchart type diagram setting forth the basic methodology according to the present invention.

### DETAILED DESCRIPTION OF THE PREFERRED METHODOLOGY

Referring now to the drawings with more specificity, the preferred methodology according to the present invention concerns a collaborative advertising method for enabling regionally located advertisers/businesses to simultaneously and directly advertise to beverage consumers at regionally located beverage provider establishments. It is contemplated that the collaborative advertising or business method may be said to comprise a series of steps which steps are tied to an individual drinking vessel outfitted or provided with a series of advertisements 11 adjacent to, or in support of, a featured beverage provider identifier, trademark, or logo as at 10.

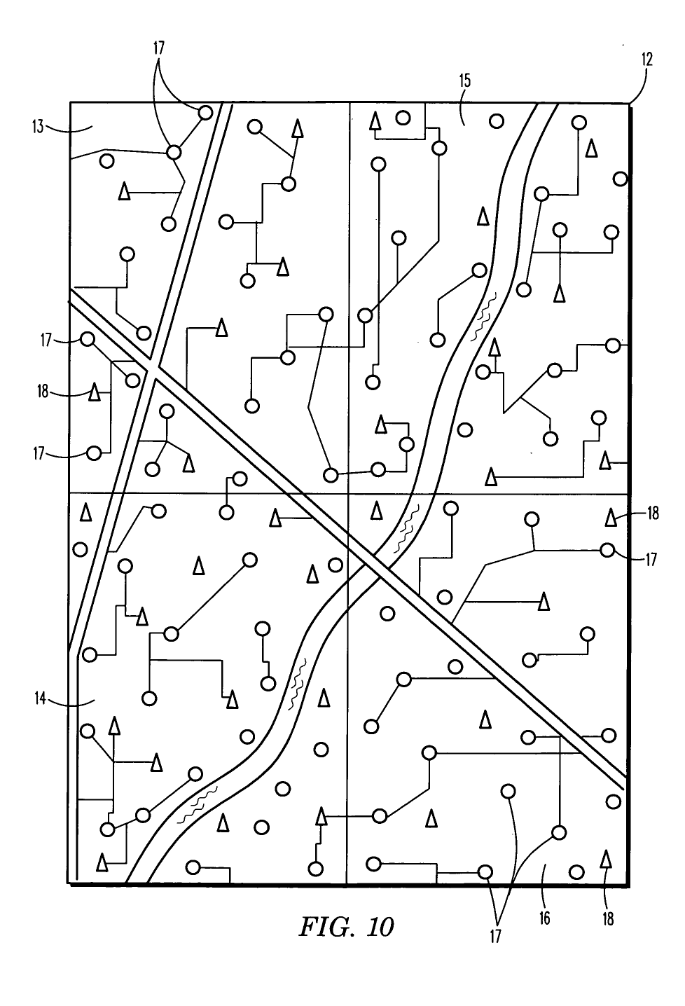

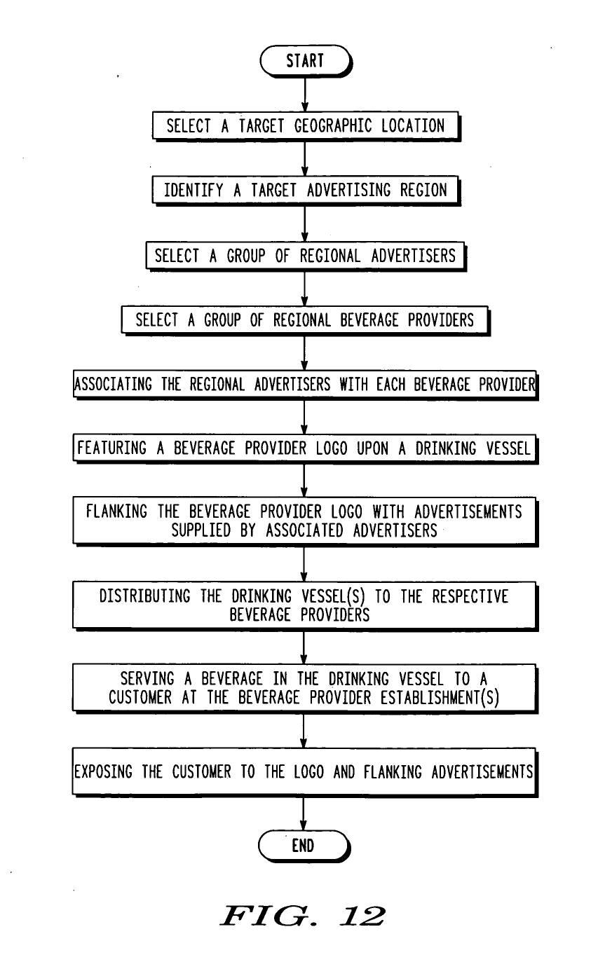

The essential methodology is depicted in flowchart form in FIG. 12. There it will be seen that a target geographic location is initially selected. Given a target geographical location (e.g. Chicago, New York, or Los Angeles) as generically depicted and referenced as at generic map 12 in FIG. 10, it may be seen that the target geographical location 12 may be divided in a series of regions as variously depicted and referenced at 13, 14, 15, and 16.

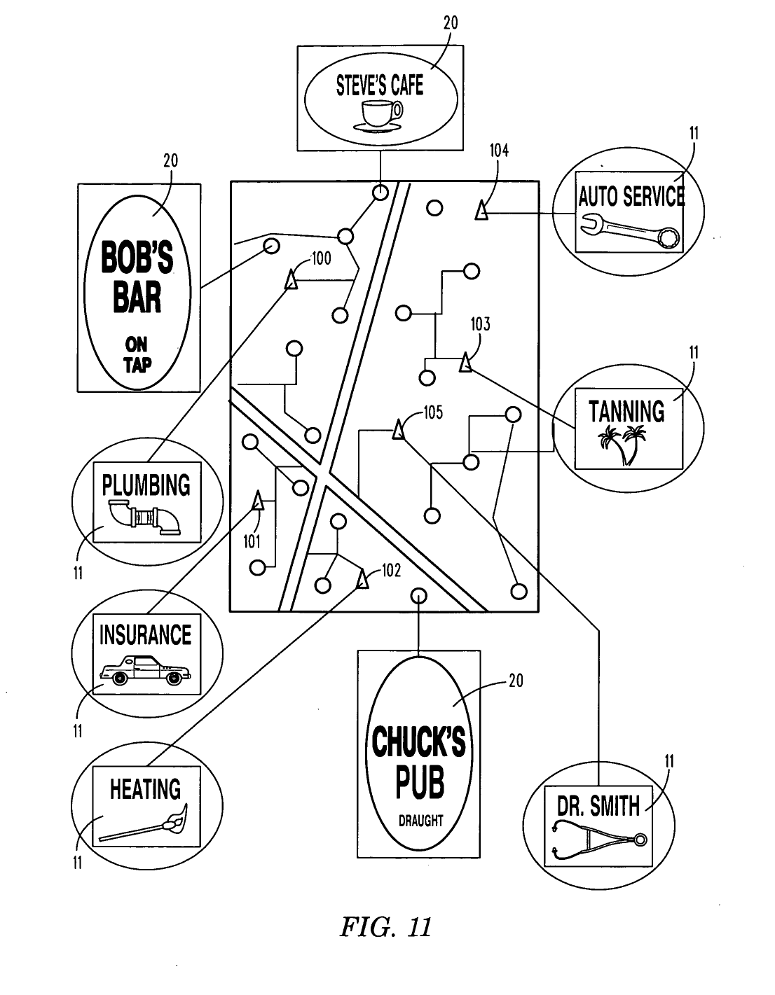

A target advertising region from within the selected geographic location is then identified. Within the target advertising region are beverage providers 17 and collaborative advertisers 18. It may be seen from an inspection of FIGS. 10 and 11 that beverage providers (and/or their respective establishments) 17 have been generically depicted as circles, and a select group of collaborative advertisers 18 have been generically depicted as triangles.

In other words, within each region 13, 14, 15, and 16 there are a number of regionally-located businesses, some of which provide beverages as a significant part of their business (e.g. pubs, taverns, public houses, restaurants, etc.) and some of which may wish to collaboratively advertise (e.g. plumbing service providers 100, insurance providers 101, heating/air conditioning service providers 102, tanning bed providers 103, automotive service providers 104, medical doctors 105, etc.). Region 13, for example, comprises twenty (20) beverage providers 17, and six (6) collaborative advertisers 18; and region 14, by contrast comprises twenty-one (21) beverage providers 17 and twelve (12) collaborative advertisers. A group of beverage providers 17 and a group of advertisers 18 are selected from within the identified region.

Notably, beverage providers 17 necessarily require glassware or other drinking vessels as at 19 to serve beverages to customers who patron their establishments 17. It is also noted that beverage providers 17 typically have their own beverage provider identifier, trademark, or logo as generally depicted and referenced at 20. The advertising method according to the present invention essentially attempts to highlight or feature the beverage provider identifier 20 for any given beverage provider establishment 17.

The beverage provider identifiers 20 are featured or highlighted by prominently displaying the identifiers 20 upon pint glasses or similar other drinking vessels 19 and flanking the identifiers 20 with grouped advertisements 11 (as representative of the entire advertiser group associated with each beverage provider) circumferentially spaced around the transverse perimeter of the glass or drinking vessels 19 in secondary positions relative to the prominent position of the provider identifiers 20.

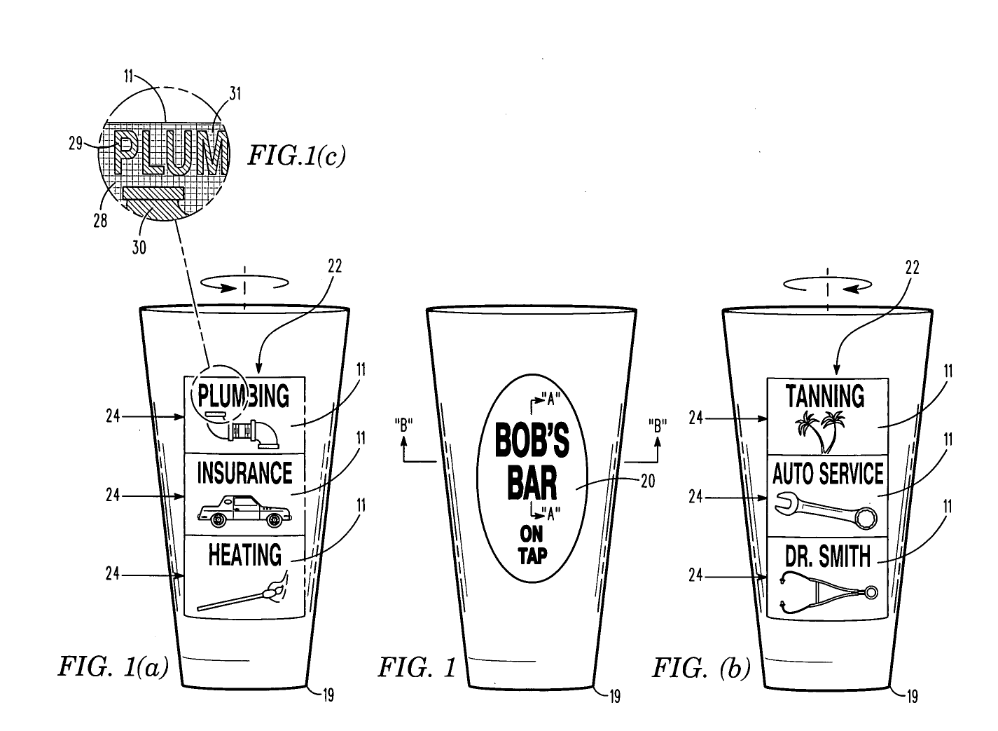

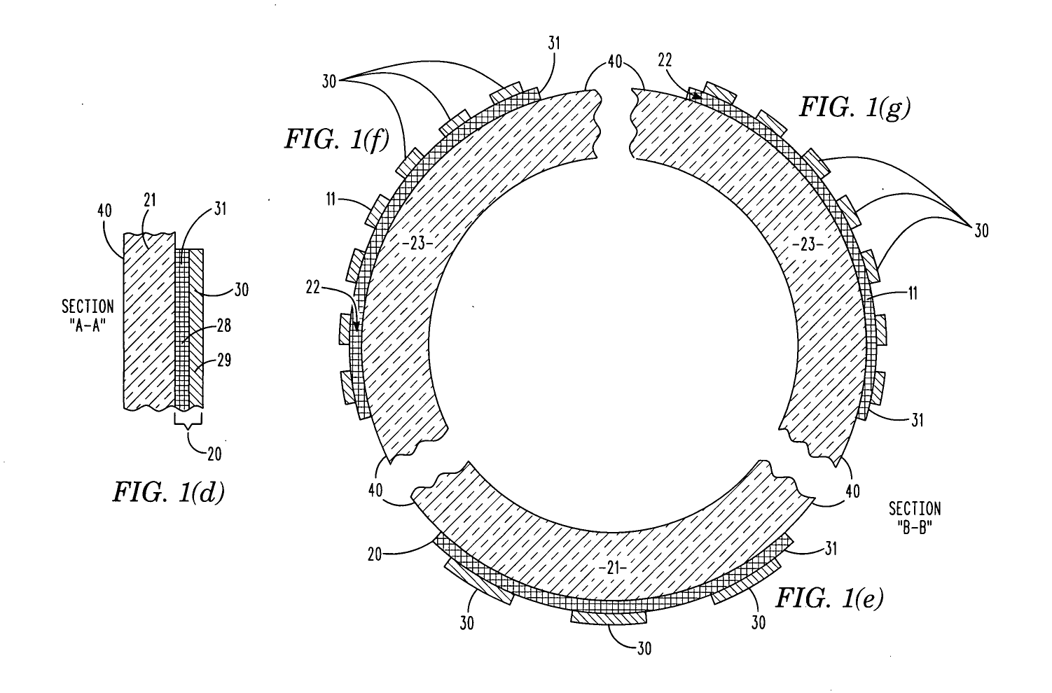

In this last regard, the reader is directed to FIGS. 1-1(b); 2-2(b); 3-3(b); and 4-4(b). From a comparative inspection of the noted figures, it will be seen that the beverage provider identifier 20 is preferably marked upon a first or primary circular arc-length section 21 of the drinking vessel 19 as further depicted and referenced in FIGS. 1(e), 4(e), 9, and 9(b).

The advertisements 11 are then preferably and randomly grouped into flanking columns 22 and marked upon second and third (or secondary) circular arc-length sections 23 as further depicted and referenced in FIGS. 1(f), 1(g), 4(f), 4(g), 7-9(a), and 9(c). The advertisers 18 thus collaborate to provide advertisements 11 which are aligned; set into columns 22; and positioned upon glassware or similar other drinking vessels 19 so as to flank the featured identifier 20.

The beverage provider 17 featured is thus provided with free glassware or drinking vessels 19 as marked with the beverage provider identifier 20 with flanking advertisement columns 22, which columns 22 comprise a number of select advertisements 11 preferably divided lengthwise into a number of advertisement slots or positions as at 24, each of which slot or position 24 is paid for by a select advertiser 18.

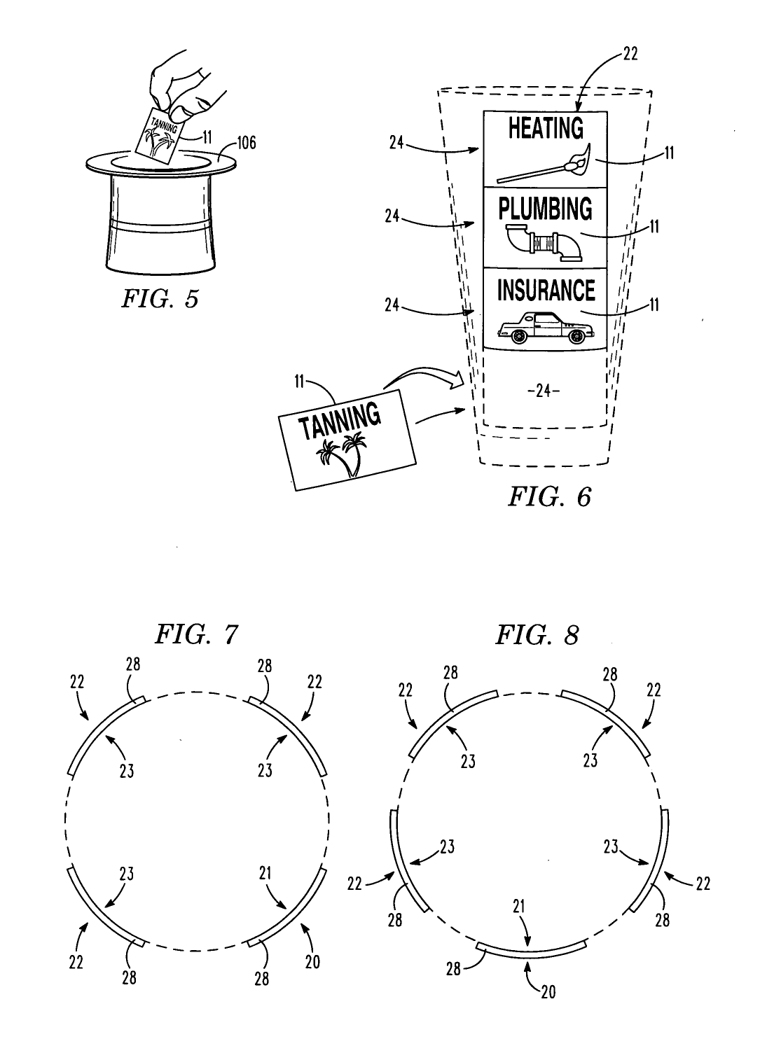

It is contemplated that the advertisements 11 may be randomly positioned within the columns 22 (as, for example, by drawing advertisements 11 from a hat 106 as generally depicted in FIG. 5) and that the columns 22 may be randomly positioned to either the left or the right or the prominently displayed provider identifier 20.

In the preferred embodiment and method, it is contemplated that three advertisements 11 may be randomly aligned into a first column 22 and three advertisements 11 may be randomly aligned into a second column 22. Since the top most advertisement 11 of each column 22 may receive undue benefit from being at the head or top of the column 22, it is contemplated that a number of column templates may be formed equal in number to the number of slots in a given column 22.

In other words, if a column 22 is to have three advertisement slots 24, then it is contemplated that three batches of templates may be provided for each beverage provider 17 such that the provider identifier 20 remains fixed at the primary, featured position upon primary circular arc-length 21 and that the advertisements 11 appearing in each column 22 differ in relative top-to-bottom position depending on the batch. The reader is thus directed to FIGS. 1-1(b); 2-2(b); and 3-3(b), which views depict three batches of advertising/identifier templates.

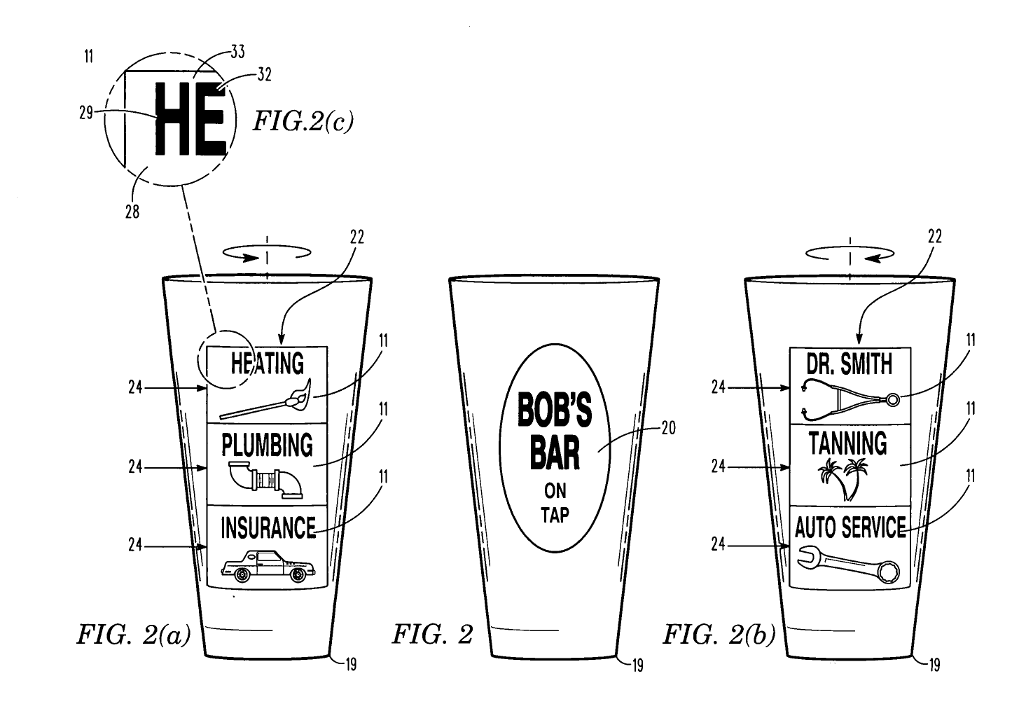

Thus, given three advertisement slots 24 appearing in each column 22, three templates or batches may be provided with a shift in each template or batch such that the topmost advertisements 11 in the first batch (e.g. Plumbing and Tanning in FIGS. 1(a) and 1(b)) are shifted downward one slot 24 in the second batch (See FIGS. 2(a) and 2(b)) relative the first batch. Similarly, the middle-positioned advertisements 11 in the first batch (e.g. Insurance and Auto Service in FIGS. 1(a) and 1(b)) are shifted to the bottommost positions 24 in the second batch (See FIGS. 2(a) and 2(b)).

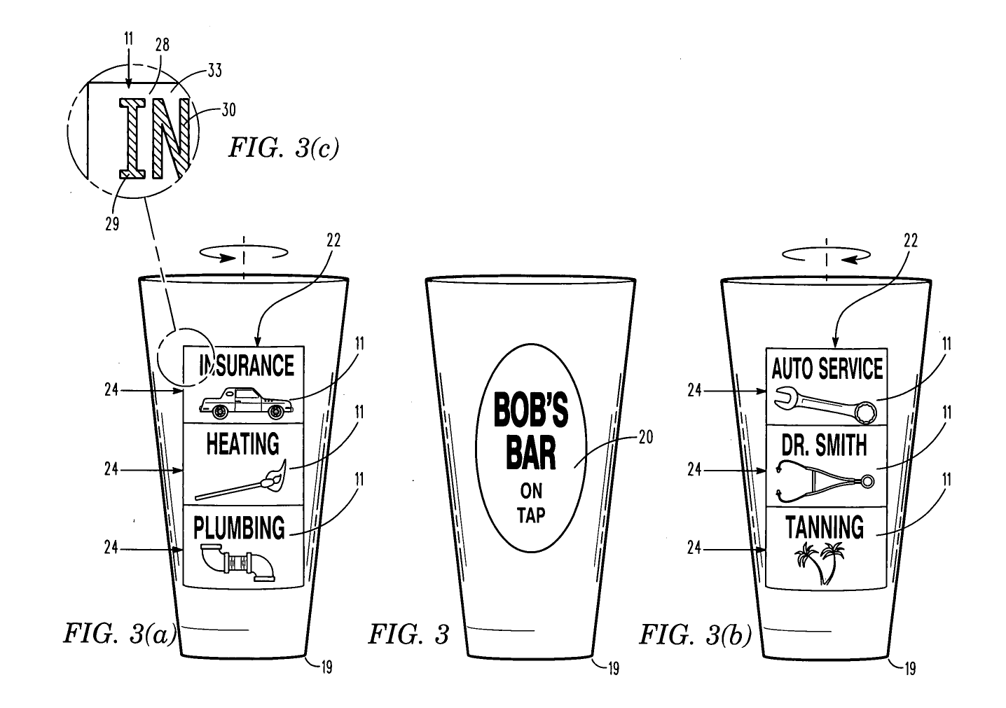

The bottommost advertisements 11 in the first batch (e.g. Heating and Dr. Smith in FIGS. 1(a) and 1(b)) are shifted to the topmost positions 24 in the second batch (See FIGS. 2(a) and 2(b)). Since there are three slots or positions 24 in each column 22, the shifting process is preferably repeated as comparatively depicted in FIGS. 3-3(b) versus FIGS. 2-2(b). Notably, the provider identifier 20 remains fixed upon the primary circular arc-length 21 regardless of the batch number.

Although the preferred number of columns 22 is two (to provide an equal number of flanking columns 22 of maximum advertisement width) to the beverage provider identifier 20, other column numbers are possible by dividing the circular transverse cross-section in appropriate circular arc-length sections as generally and comparatively depicted in FIG. 7 (depicting a three-column advertisement arrangement with primary circular arc length section 21 for the provider identifier 20) and FIG. 8 (depicting a four-column advertisement arrangement with primary circular arc length section 21 for the provider identifier 20).

By way of further description, referencing FIG. 7, given three columns 22 of advertisements 11 are desired as generally depicted, it is contemplated that the beverage provider identifier 20 may be centered on a primary circular arc-length section 21 subtended by an angle of 90 degrees, and each successive column 22 may be centered on successive or secondary circular arc-length sections 23 each subtended by successive 90-degree sections.

Stated another way, if, for example, there are to be two flanking advertisement columns 22 adjacent one beverage provider identifier 20, then the circular arc length sections 21 and 23 (upon which the identifier 20 and columns 22 are respectively centered) may be defined by degree angle(s) each subtended by: [360 degrees divided by the sum of advertisement columns (e.g. “2”) and provider identifier (i.e. “1”) (e.g. 360 degrees divided by (2+1)=120 degrees)]. The circular arc length sections of a four advertisement-column drinking vessel (if practicable) would theoretically be defined by degree angles subtended by: [360 degrees divided by (4+1)=72 degrees].

The foregoing examples depict scenarios in which the beverage provider identifier 20 is of a similar lateral width as compared to the advertisement columns 22. If the design of the beverage provider identifier 20 for a particular beverage provider 17 requires relatively more transverse circular arc length than either of the advertisement columns 22, circular arc length adjustments could conceivably be made to accommodate beverage provider identifier 20 specifications.

In terms of marking the glassware or drinking vessels 19, it is contemplated that state of the art marking techniques may be used. In this regard, the preferred process may be referred to as Direct Printing (2 color) utilizing the Screen Printing technique, and color enamels for decorative effect or image transfer. Also after the color enamel is applied, the glasses are then “fired”, or brought up to a temperature high enough to permanently fuse the enamel onto the surface of the glass.

The glasses are preferably fired via a large annealing kiln such as a Lehr that is able to run multiple glasses through it by means of a conveyor belt. It is contemplated that a duotone color scheme is to be preferred, and thus the preferred marked drinking vessels 19 comprise a solid backdrop color layer firstly layered upon the drinking vessel (as at 28) upon which a second layer of print material is positioned (as at 29) so as to provide duotone vessels 19 for enhancing the overall visual appeal of the drinking/advertising vessel 19.

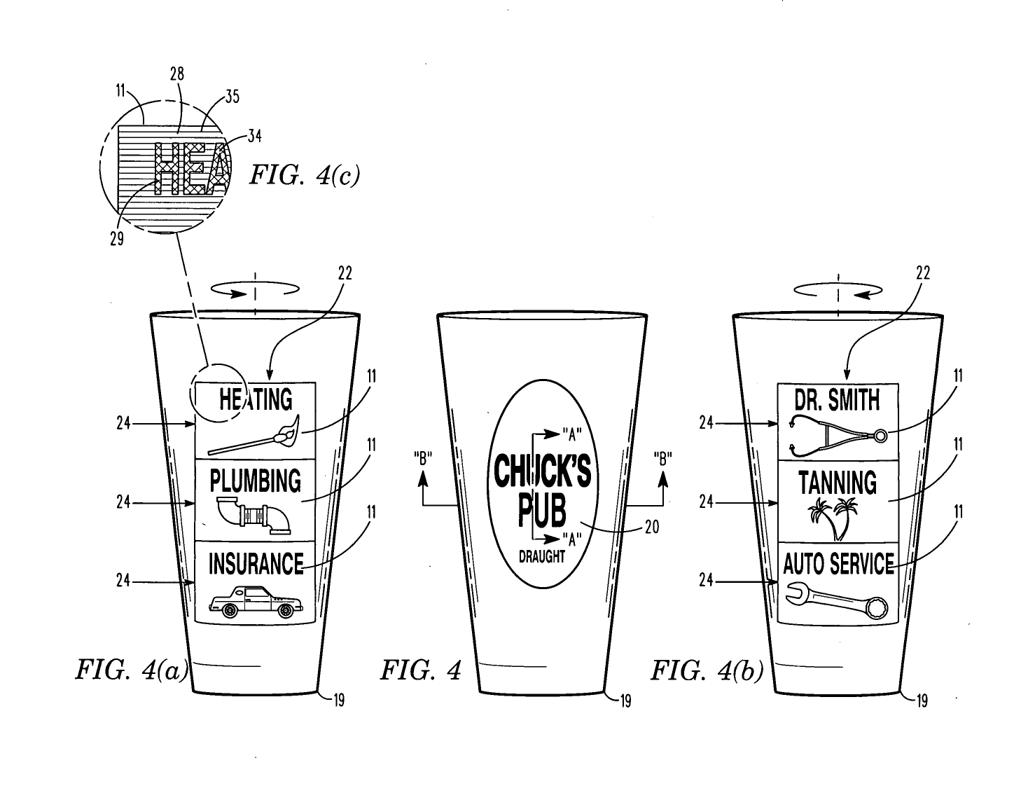

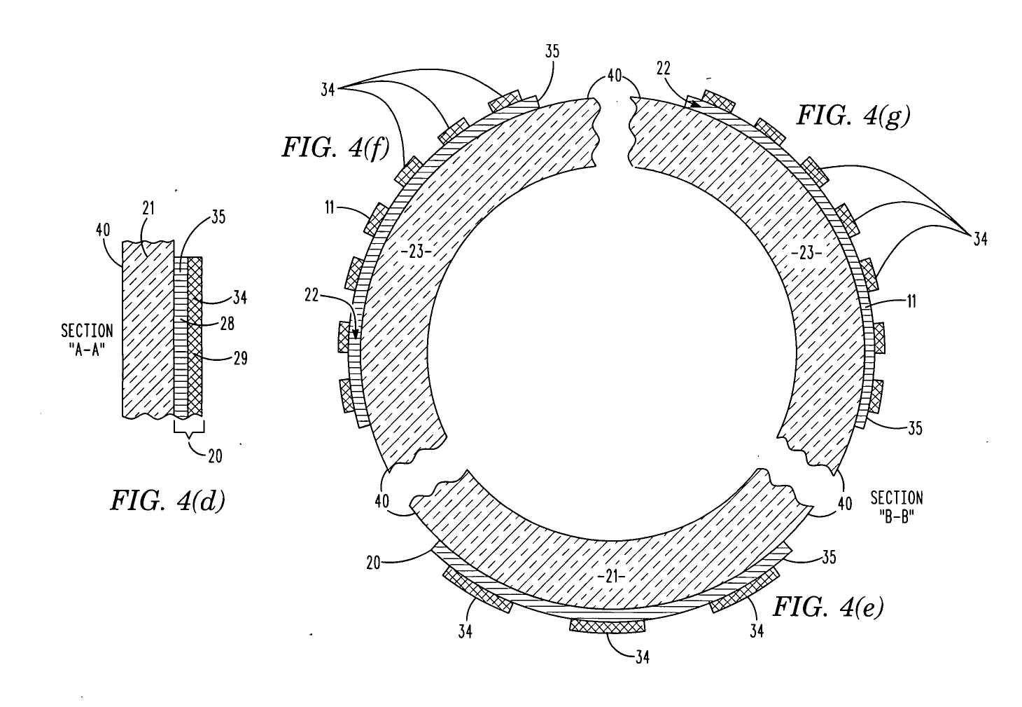

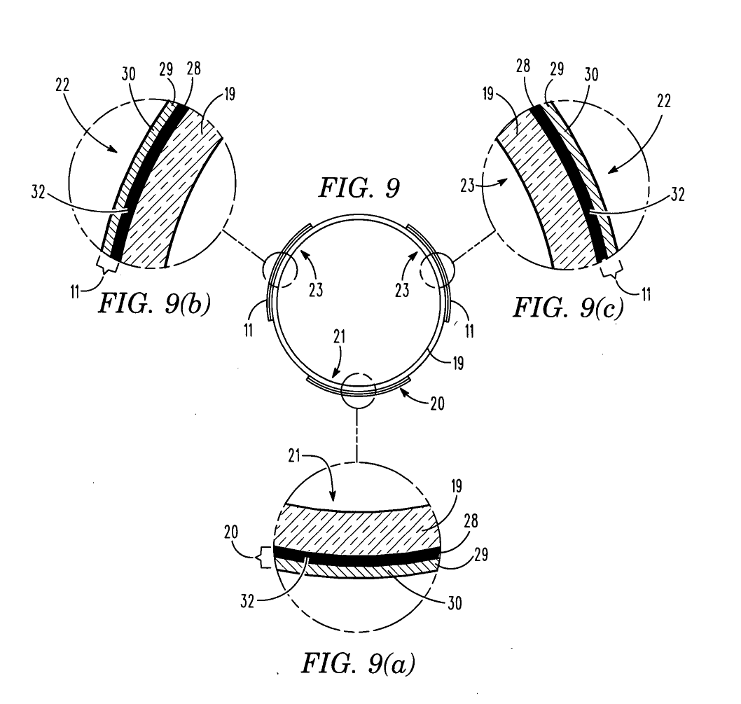

The beverage providers 17 may thus select a color scheme according to their tastes or target consumer, as exemplified by the following: (1) green 30 text/imagery on a yellow 31 background as generally depicted with green 30 and yellow 31 type hatch markings in FIGS. 1(c)-1(g); (2) black 32 text/imagery on a white 33 background as depicted in FIG. 2(c); (3) green 30 text/imagery on a white 33 background as depicted in FIG. 3(c); (4) orange 34 text/imagery upon a blue 35 background as depicted in FIG. 4(c)-4(g); or green 30 text/imagery on a black 32 background as depicted in FIGS. 9(a)-9(c).

The foregoing color scheme examples are contemplated as examples of preferred types of color schemes. Other color schemes are also contemplated, such as red on black, black on red, pink on red, pink on black, etc. Further, it is contemplated that the beverage provider 17 may elect a single layer 28 of colored material(s) or monochromic portrayal of the various advertisements 11 and beverage provider identifiers 20 directly upon the clear glass material of the drinking vessel 19 either in negative or positive formats.

The present invention thus contemplates that the method is tied to a collaborative advertising tool (e.g. a drinking vessel as at 19) for enabling regionally located advertisers to simultaneously advertise to beverage consumers. In this regard, it is contemplated that the collaborative advertising tool may be said to comprise a drinking vessel as at 19; a primary provider identifier as at 20; and a series of select advertisements as at 11.

The drinking vessel 19 comprises an outer vessel surface as at 40, and a circular transverse cross-section. The circular transverse cross-section comprises a series of (i.e. at least three) circular arc length sections of which there are (1) a primary arc length section as at 21 and (2) at least two secondary arc length sections as at 23. The secondary arc length sections 23 flank the primary arc length section 21.

The primary provider identifier is displayed upon the outer vessel surface 40 at the primary arc length section 21, and the series of select advertisements 11 are divided into at least first and second advertisement groups, the first and second advertisement groups are displayed upon the outer vessel surface 40 at the secondary arc length sections 23 for flanking the primary provider identifier 20. The drinking vessel 19 may be exposed to a customer for exposing the customer to the primary provider identifier 20 and the flanking select advertisements 11.

While the foregoing specifications set forth much specificity, the same should not be construed as setting forth limits to the invention but rather as setting forth certain preferred embodiments and features. For example, as prefaced hereinabove, it is contemplated that the present inventive methodology essentially provides a collaborative advertising method directed to a select or target geographical location as typified by a metropolitan location.

Within the geographical location 12, any number of regions can be delineated and identified, and thus the method may be said to comprise the step of identifying a target advertising region (as exemplified by regions 13-16) within the geographical location 12. Within the target advertising region there may be any number of businesses willing to participate in the method as previously described to them, and thus the method contemplates first contacting potentially willing businesses within the advertising region to solicit their interest in collaborating in the described method.

From those contacted, a number of willing businesses is compiled into a listing, which listing preferably comprises two types of parties, namely, those parties primarily interested in collaboratively advertising as exemplified by advertisers 19 upon drink ware or drinking vessels (as at 19) and those parties primarily interested in the business of serving beverages in drink ware or drinking vessels 19 outfitted with collaborative advertising or advertisements 11.

The chosen advertising parties or advertisers 18 are grouped with each respective beverage-providing party or beverage provider 17 (i.e. a single beverage provider is matched, linked or otherwise grouped with a group of advertisers 18), and all parties contribute a party-identifying and/or advertising template for marking a portion of a drinking vessel 19 as exemplified or typified by a pint glass.

The advertisements 11 are numbered by region and/or selective decision and made divisible into columns 22 of advertisements 11, which individual columns 22 preferably comprise equal numbers of advertisements 11 (but not necessarily so). The advertisement columns 22 are then positioned at circumferentially spaced portions of the drinking vessel 19 so as to flank the featured beverage provider logo, trademark, or identifier 20.

Once the marked drinking vessels 19 are delivered or distributed to the beverage providers 17 and/or their establishments, beverages may be served to individual customers/consumers in the drinking vessel(s) 19 thereby exposing the customer/consumer to the prominently displayed select provider identifier 20 and secondarily displayed select advertisements 11.

Notably, the select provider identifier 20 or logo may be displayed upon prominent first circular arc length sections (as at 21) of a plurality of drinking vessels, which circular arc length section 21 is determined by the numbers of columns 22 to be included in flanking positions relative to the prominently displayed beverage provider identifier or logo 20.

Stated another way, it is contemplated that the collaborative advertising method may essentially comprise the initial step of selecting a group of businesses from within a target advertising region. Those businesses wishing to collaboratively advertise would submit business identifying information for displaying the information to would-be customers via a collaborative advertising vessel (e.g. drinking vessel 19), and such information may be exemplified by the beverage provider identifier(s) 20 and the select advertisements 11.

The businesses, as selected from within the target advertising region, may be divided into a beverage provider group and an advertiser group, whereafter each beverage provider from the beverage provider group is matched, linked, or further grouped to the entire group of advertisers within the advertiser group. The advertisers may preferably be randomly displayed, group displayed, and/or column-displayed for flanking the beverage provider of each advertiser/beverage provider grouping.

The number of advertisers associated with each beverage provider may preferably be divisible by a group number for defining the number of columns of the column-displayed advertiser information. The beverage provider may then be provided with the advertising vessels as provided in a number of batches equal to the number of advertisements in each column.

The obtained information from the beverage providers is displayed upon primary vessel sections of the advertising vessel, and the obtained information from the advertisers is displayed upon secondary vessel sections of the advertising vessel. The vessels are then served or otherwise presented to customers of the beverage providers for exposing the customers to the primarily displayed beverage provider information and secondarily displayed advertiser information.

Accordingly, although the invention has been described by reference to certain preferred structural layouts and certain methodologies, it is not intended that the novel arrangements and methods be limited thereby, but that modifications thereof are intended to be included as falling within the broad scope and spirit of the foregoing disclosures and the appended drawings.

I claim:

1. A collaborative advertising method for enabling regionally located advertisers to simultaneously advertise to beverage consumers, the method comprising the steps of:
selecting a target geographical location;
identifying a target advertising region from within the geographical location;
selecting a group of advertisers from within the target advertising region, the advertisers of the select group each contributing a select advertisement;
selecting a beverage provider from within the target advertising region, the select beverage provider contributing a select provider identifier;
associating the select group of advertisers with the select beverage provider;
displaying the select provider identifier upon a primary first arc-length section of a drinking vessel;
displaying the select advertisements adjacent the select provider identifier upon secondary, second and third arc-length sections of the drinking vessel;
distributing the drinking vessel with primarily displayed select provider identifier and secondarily displayed select advertisements to the select beverage provider; and
serving a beverage in the drinking vessel to a customer at a beverage provider establishment thereby exposing the customer to the primarily displayed select provider identifier and secondarily displayed select advertisements.

2. The method of claim 1 comprising the steps of:
displaying the select provider identifier upon primary first arc length sections of a plurality of drinking vessels;
displaying the select advertisements adjacent the select provider identifier upon secondary arc length sections of the plurality of drinking vessels;
distributing the plurality of drinking vessels with primarily displayed select provider identifiers and secondarily displayed select advertisements to the select beverage provider; and
serving a plurality of beverages in the drinking vessels to a plurality of customers at the beverage provider establishment thereby exposing the plurality of customers to the primarily displayed select provider identifiers and secondarily displayed select advertisements.

3. The method of claim 1 comprising the steps of:
selecting a group of beverage providers from within the target advertising region, the beverage providers of said select group each contributing a select provider identifier;
associating the select group of advertisers with each select beverage provider;
displaying each select provider identifier upon a primary first arc length section of a provider-specific drinking vessel;
displaying the select advertisements adjacent the select provider identifiers upon secondary arc length sections of each provider-specific drinking vessel;
distributing the provider-specific drinking vessels with primarily displayed select provider identifiers and secondarily displayed select advertisements to the respective beverage providers of said select group; and
serving a beverage in the provider-specific drinking vessels to a beverage customer at each provider-specific establishment thereby exposing the beverage customers at the provider-specific establishments to the primarily displayed select provider identifiers and secondarily displayed select advertisements.

4. The method of claim 3 comprising the steps of:
respectively displaying each select provider identifier upon primary first arc length sections of a plurality of drinking vessels;
respectively displaying the select advertisements adjacent the select provider identifiers upon secondary arc length sections of the plurality of drinking vessels;
respectively distributing the plurality of drinking vessels with primarily displayed select provider identifiers and secondarily displayed select advertisements to the select beverage providers; and
respectively serving a plurality of beverages in the drinking vessels to a plurality of beverage customers at the provider-specific establishments, thereby exposing the plurality of beverage customers to the primarily displayed select provider identifiers and secondarily displayed select advertisements.

5. The method of claim 1 wherein the select advertisements are randomly displayed adjacent the select provider identifier upon secondary arc length sections of the drinking vessel.

6. The method of claim 2 wherein the select advertisements are group-displayed adjacent the select provider identifier upon secondary arc length sections of the drinking vessel.

7. The method of claim 3 wherein the select advertisements are column-displayed adjacent the select provider identifier upon secondary arc length sections of the drinking vessel.

8. The method of claim 7 wherein the select advertisements are displayed in flanking positions relative to the select provider identifier upon secondary arc length sections of the drinking vessel.

9. The method of claim 6 wherein the select advertisements comprise a total advertisement number, the total advertisement number being evenly divisible by two for displaying an even number of advertisements on each side of the select provider identifier.

10. The method of claim 7 wherein the column-displayed select advertisements comprises a number of advertisements per column, the number of advertisements per column for defining a number of drinking vessel batches.

11. A collaborative advertising method, the method comprising the steps of:
identifying a target advertising region;
selecting a group of advertisers from within the target advertising region, the advertisers of the select group each contributing a select advertisement;
selecting a group of beverage providers from within the target advertising region, the beverage providers of the select group each contributing a select provider identifier;
grouping the selected advertisers with each selected beverage provider;
displaying the select provider identifier of each selected beverage provider upon a primary first section of a provider-specific drinking vessel;
displaying the select advertisements adjacent each select provider identifier upon secondary sections of the provider-specific drinking vessels;
distributing the drinking vessels with primarily displayed select provider identifiers and secondarily displayed select advertisements to the selected beverage providers; and
serving the drinking vessels to customers at beverage provider establishments thereby exposing the customers to the primarily displayed select provider identifiers and secondarily displayed select advertisements.

12. The method of claim 11 wherein the select advertisements are randomly displayed adjacent the select provider identifier upon secondary sections of the drinking vessel.

13. The method of claim 11 wherein the select advertisements are group-displayed adjacent the select provider identifier upon secondary sections of the drinking vessel.

14. The method of claim 11 wherein the select advertisements are column-displayed adjacent the select provider identifier upon secondary sections of the drinking vessel.

15. The method of claim 14 wherein the select advertisements are displayed laterally adjacent the select provider identifier upon secondary sections of the drinking vessel.

16. The method of claim 13 wherein the select advertisements total an advertisement number, the advertisement number being evenly divisible by a select number for displaying the select number of advertisement groups adjacent the select provider identifier.

17. The method of claim 13 wherein the group-displayed select advertisements comprises a number of advertisements per group, the number of advertisements per group for defining a number of drinking vessel batches per beverage provider.

18. A collaborative advertising method, the method comprising the steps of:
selecting a group of businesses from within a target advertising region;
obtaining displayable information from each selected business;
dividing the group of businesses into a beverage provider group and an advertiser group;
associating each beverage provider from the beverage provider group with every advertiser from the advertiser group;
displaying the obtained information from the beverage providers upon primary vessel sections of respective, provider-specific vessels;
respectively displaying the obtained information from each advertiser upon a secondary vessel section adjacent the primary vessel sections;
providing customers of the respective beverage providers with the provider-specific vessels thereby exposing the customers to the displayed beverage provider and advertiser information.

19. The method of claim 18 wherein the displayed advertiser information is randomly displayed.

20. The method of claim 18 wherein the displayed advertiser information is group displayed.

21. The method of claim 18 wherein the displayed advertiser information is column-displayed.

22. The method of claim 18 wherein the displayed advertiser information flanks the displayed beverage provider information.

23. The method of claim 20 wherein the advertiser group comprises a number of advertisers, the number of advertisers being divisible a group number, the group number for defining a number of groups for the group-displayed advertiser information.

24. The method of claim 20 wherein the group-displayed advertiser information comprises a number of advertisements per group, the number of advertisements per group for defining a number of provider-specific vessel batches per beverage provider.

25. A collaborative advertising tool for enabling regionally located advertisers to simultaneously advertise to beverage consumers, the collaborative advertising tool comprising:
a drinking vessel, the drinking vessel comprising an outer vessel surface, and a circular transverse cross-section, the circular transverse cross-section comprising a series of circular arc length sections, the series of circular arc length sections comprising a primary arc length section and at least two secondary arc length sections, the secondary arc length sections flanking the primary arc length section;
a primary provider identifier, the primary provider identifier being displayed upon the outer vessel surface at the primary arc length section; and
a series of select advertisements, the series of select advertisements being divided into at least first and second advertisement groups, the first and second advertisement groups being displayed upon the outer vessel surface at the secondary arc length sections for flanking the primary provider identifier, the drinking vessel being exposable to a customer for exposing the customer to the primary provider identifier and the flanking select advertisements.
